(19) United States
(12) Patent Application Publication
(10) Pub. No.: US 2023/0133443 A1
(43) Pub. Date: May 4, 2023

(54) SYSTEM FOR AND METHOD OF PRODUCING A WELD ARC ADDITIVE MANUFACTURING PART WITH GRANULAR SUPPORT

(71) Applicant: Michigan Technological University, Houghton, MI (US)

(72) Inventor: Gerald C. Anzalone, Los Osos, CA (US)

(73) Assignee: Michigan Technological University, Houghton, MI (US)

(21) Appl. No.: 17/912,249

(22) PCT Filed: Mar. 19, 2021
(86) PCT No.: PCT/US2021/023169

§ 371 Date: Sep. 16, 2022

Related U.S. Application Data
(60) Provisional application No. 62/991,663, filed on Mar. 19, 2020.

(51) Int. Cl. B23K 9/04; B22F 10/38; B22F 10/43; B22F 5/10; B22F 10/68; B22F 10/73; B22F 12/60; B22F 10/36; B22F 10/85

(52) U.S. Cl. CPC B23K 9/044; B22F 10/385; B22F 10/43; B22F 5/10; B22F 10/68; B22F 10/73; B22F 12/60; B22F 10/36; B22F 10/85; B33Y 10/00

(57) ABSTRACT

The invention is a system for and method of manufacturing metallic parts through weld arc additive manufacturing with conductive granular media as support, to manufacture parts which have overhangs, hollow sections, a plurality of openings, a geometry having a discontinuous structure when formed by additive manufacturing steps that is joined, or a combination of geometries known in the art of manufacturing that could heretofore only be produced by cutting and assembling a variety of different parts. The system and method of the invention contemplate use of conductive granular media support material which may become at least partially incorporated in, or part of, a final part produced using the system or method of the invention.

### CROSS-REFERENCE TO RELATED APPLICATIONS

This application claims priority to Patent Cooperation Treaty (PCT) Application No. PCT/US2021/23169, filed on Mar. 19, 2021 which claims priority to U.S. Provisional Application No. 62/991,663, filed on Mar. 19, 2020, both of which are hereby incorporated by reference in their entirety.

### INTRODUCTION

The system for and method of producing a weld arc additive manufacturing (“WAAM”) part with granular support contemplates an improvement upon WAAM techniques by integration of support which may be a conductive material, some of which may become part of the final manufactured part—the invention is known commercially as WAAMS (Weld Arc Additive Manufacturing+Support). The method of producing a WAAMS part includes steps for additive manufacturing and welding, and contemplates welding directly onto a conductive, granular support substrate. The combination of the method and system of the invention allow for production of parts having overhangs, hollows, and other geometries that are otherwise not available when producing with WAAM techniques. The resulting part itself produced using a system for or method of WAAMS is novel in the art. Any reference to “wire” in the WAAMS acronym is in no way limiting, as all forms of welding are contemplated, including wire based welding, by this disclosure of various embodiments of the invention, but one embodiment of the system for and method of the invention includes a wire welder and steps for wire welding.

### BACKGROUND

The invented system for and method of producing a manufactured part using Weld Arc Additive Manufacturing (WAAM) with granular support is an improvement upon existing methods of additive manufacturing using weld materials. The resulting part produced through the invented method has unique characteristics resulting from being produced through the invented method. The system for producing a WAAM part with granular support is unique.

Gas-metal arc welding (GMAW), tungsten-inert gas welding (TIG) or stick welding have been crudely employed to produce “built-up” pieces that later require significant machining to produce usable, useful parts, e.g., repairing features broken off an original component, or as wear-plating on high-wear metal components, e.g., conveyor belt discharge chutes surfaces in a mining environment or road grader blades. Instead of these, welding methods to produce useful geometries through WAAM may be employed. One aspect of the invention is the contemplation of an improvement in WAAM techniques through the integration of support in the form of material which may be conductive, some of which may become part of the final manufactured part—the invention is known commercially as WAAMS (Weld Arc Additive Manufacturing+Support). Any reference to “wire” in the WAAMS acronym is in no way limiting, as all forms of welding are contemplated, including wire based welding, by this disclosure of various embodiments of the invention, but one embodiment of the system for and method of the invention includes a wire welder and steps for wire welding.

WAAMS is additionally novel from sinter-based additive manufacturing methods, e.g., laser and electron beam sintering. These sinter-based methods are only capable of producing low angle and horizontal overhangs with the addition of energy inputs melting the surface of a very fine powder and at a very low production rate. The sintering methods employ specially prepared fine metal powders that are inherently hazardous both to health and safety as they represent an inhalation and explosion risk. These typically must therefore be performed in tightly controlled, enclosed environments whereas WAAMS has no such limitations and is not inherently hazardous.

### DESCRIPTION OF FIGURES

FIG. 1 illustrates a part created using the steps and system of the invention which includes fingers, a frame, and characteristics of a part, prior to this invention, were impossible through additive manufacturing

FIG. 2 illustrates a part capable of being manufactured using the system and method of the invention, having internal and external overhang features.

FIG. 3 illustrates geometries capable of being manufactured using the system and method of the invention having overhang features.

FIG. 4 illustrates geometries capable of being manufactured using the system and method of the invention having box-like features.

FIG. 5 illustrates structure used in the system and method of the invention, specifically including a baseplate frame, granular media, fingers, and a layer of a WAAM part.

FIG. 6 illustrates an embodiment of the system of the invention which may be utilized to perform the method of the invention.

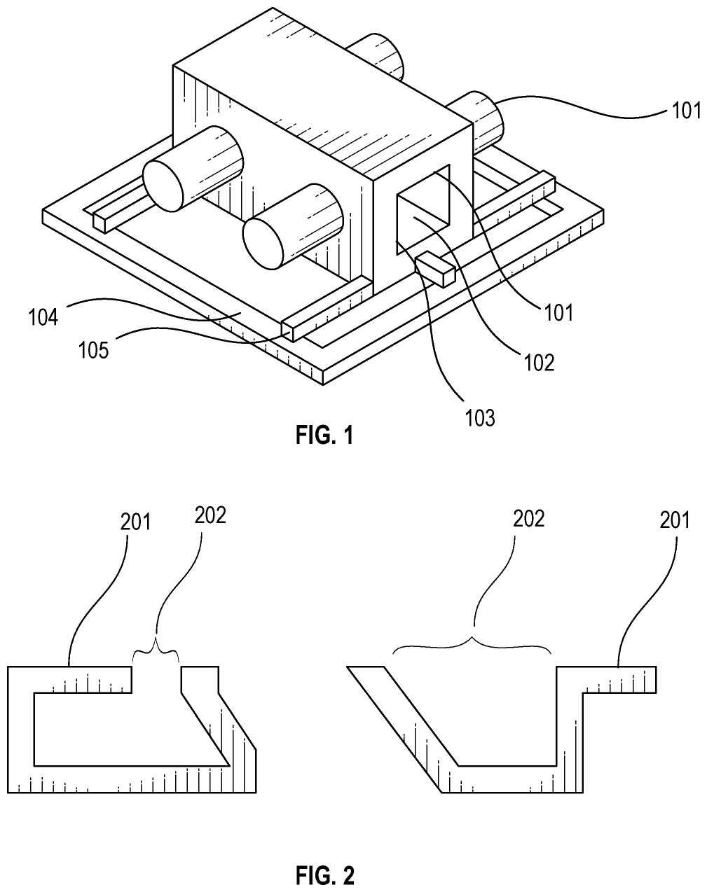

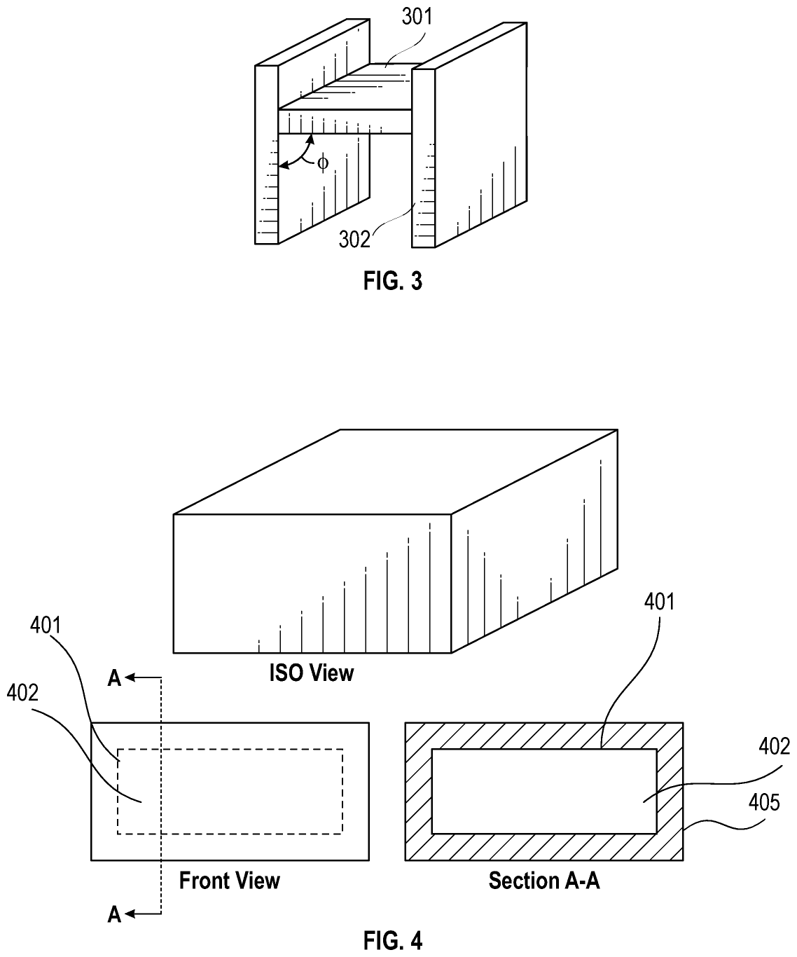

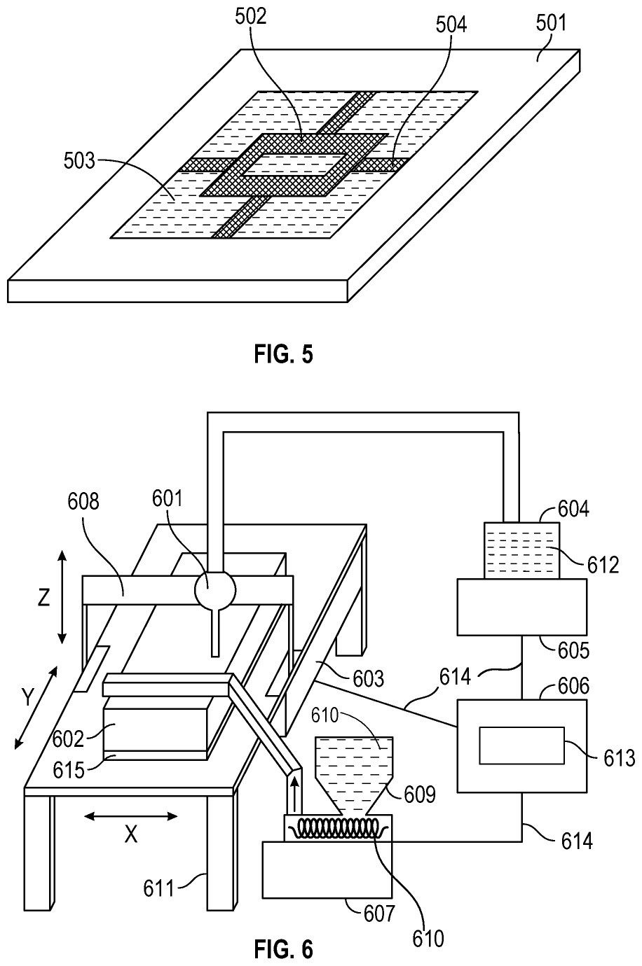

### DETAILED DESCRIPTION

This invention generally contemplates a system for and method of additive manufacturing of metallic parts using conductive granular media as support.

Parts formed using the invented system and method may be manufactured by the invented system and method to have virtually any geometry.

The invention further contemplates a system comprising several sub-components for manufacturing a metallic part using WAAM with conductive granular media as support.

The invention further contemplates steps for manufacturing a metallic part using WAAM with conductive granular media as support.

The system for and method of manufacturing metallic parts through WAAM with conductive granular media as support allows for parts to be manufactured which have overhangs 101, 201, which may be at varying angles such as Phi (1) 301 hollow sections 102, 402 a plurality of openings 103, 202 a geometry having a discontinuous structure when formed by additive manufacturing steps that may be joined, such as two islands of materials formed and then ultimately connected 405, 302 and or a combination of geometries known in the art of manufacturing that could heretofore only be produced by cutting and assembling a variety of different parts. Section A-A of FIG. 4 shows a geometry having a discontinuous structure when formed by additive manufacturing steps that may be joined, such as two islands of materials formed and then ultimately connected 405, in that as the shaded sections are printed one layer at a time, from bottom to top, the shaded pillars on each side, which are the walls of the part shown in FIG. 4, are islands in space until the top of the part is printed, joining the islands of material formed using the system for and method of weld arc additive manufacturing with support.

The system and method of the invention contemplate use of a welder having a power supply and a power modulator 605, and a weld device for depositing weld 601, and welding filler material distributor for delivering welding filler material to the weld device 604, and conductive granular media support material 503, 610 which may become at least partially incorporated in, or part of, a final part 502 produced using the system or method of the invention. The system also includes a baseplate 615. No other WAAM systems or methods in the art of additive manufacturing contemplate the use of conductive materials which are incorporated as described by this disclosure.

The system and method of the invention do not use a binder which would otherwise be incorporated into a final part manufactured using the system or method of the invention.

The novel aspects of the system and method of the invention further include steps for utilizing the conductive nature of the granular media to start an arc and initiate printing directly on the granular media, producing parts substantially disconnected, or substantially free floating, from any anchor points.

In embodiments where the granular media is incorporated into a final part, the system of and method of WAAM using conductive granular media for support may incorporate the media into the final part as an alloying constituent, creating, in at least one embodiment of the invention, a layer of metallic material having slightly different properties than the majority of a part manufactured according to this invention, which is composed substantially entirely of the subject weld material.

In at least one embodiment, the unique nature of the invention for starting an arc and printing directly into the granular media allows for manufacturing a part using WAAMS which is substantially not affixed to a substrate and does not require substantial cutting or breaking to remove a produced part from the substrate.

In another embodiment of the invention, fingers or small portions of weld material may be printed in accordance with the novelty of the invention, where such fingers are created via a method step of an embodiment of the invention, and substantially anchor a part to a frame 104, 501 that may substantially enclose the granular media, forming a “sandbox” 602, within the system of the invention. In this embodiment of the method of the invention, when the part is complete, the fingers may be cut to release it from the frame. The fingers 105, 504 may be optional, depending on the geometry of the granular media. An example of a part created using the steps and system of the invention is shown below, which includes fingers, a frame, and characteristics of a part, prior to this invention, were impossible through additive manufacturing.

In an embodiment of the invention where the granular media 503 is used to alloy a part manufactured according to the invention, an element of the system of the invention is a power supply modulator or controller. Said modulator or controller may increase energy input at a media/part interface, thereby increasing the rate of melting of the media. In such an embodiment, mixing is significant producing a layer having a relatively constant composition intermediate between that of the support media and filler/weld material and a function of the energy applied.

In yet another embodiment, the granular media of the invention may have a strategically determined geometry and/or size distribution and compaction strategy to affect the packing and mobility of the support media and topography of the finished part surface. For instance, monosize spherical grains have a relatively low packing density that lead to a bumpy finished surface having greater surface area, which may be beneficial based on the application and use of a resulting component made by the method for forming or the system of the invention e.g., for cooling water passages in which turbulent flow and large surface area enhances cooling. Monosize spherical grains also tend to naturally pack, requiring little or no compaction whereas a different particle geometry and/or different or variable geometry may require vibration to thoroughly compact. Acicular and lamellar grains having large aspect ratios are likely to pack tightly with minimal vibration and greater mobility compared to monosize spherical grains as they tend to align when vibrated, leading to a smoother finished surface and easier removal of the loose granular media from the finished part. Media geometry may also be designed to stay in place as a permanent part feature, e.g. star-like or jack-shaped grains could be expected to nest making their removal impossible and forming an tangled lattice-like structure in the passage, greatly increasing surface area, tortuosity, again potentially beneficial based on the application of the resulting part e.g. for water cooling passages.

The method and system of the invention are scalable, permitting production of parts ranging in size from a few inches to several feet.

The invention contemplates method steps and a system for manufacturing a near net shape metallic part having geometries that cannot be produced by any other WAAM process or that can only be assembled by attachment of multiple separate bodies.

The system for and method of the invention further contemplate production of a part manufactured with WAAM using conductive granular media in a single pass build or additive operation step.

At least one embodiment of the system and method of the invention contemplates production of a part manufactured with WAAM with support of a conductive granular media using a first subject weld material.

Another embodiment of the invention contemplates a second subject material manufactured via WAAM with conductive granular media wherein the second weld material is added on top of, below, beside, within, throughout, around, or otherwise in conjunction with the said first material to the said first subject weld material, forming a volume having properties different from the bulk of the part. For instance, a part may be produced with a stainless-steel exterior and a plain carbon steel interior, resulting in a composite part having a corrosion resistant exterior and stronger plain carbon steel interior. Similarly, compatible alloys having similar crystal structures, but different properties may be used in a single part requiring properties that vary by location, e.g., a hard, high carbon steel surface may be made integral with a finished part substantially printed with low carbon steel.

Another embodiment of the invention contemplates strategically engineered interior geometries. As a simple example, interior cavities may be selected for light weighting the finished part and the resulting method steps for creation of said cavities are included in the method steps of the invention. Similarly, additional structure is contemplated to be added to the system of the invention making the invention capable of performing the method steps. A more complex example includes steps or structure allowing for creation of interior geometries varying in size, strength, weight, or capability. When used in conjunction with topology optimization, the method for and system of the invention may be used to create geometries that simply cannot be produced by any manufacturing method except additive manufacturing.

Another embodiment of the invention contemplates a method step and components of a system for creation of partially filled cavities in which the invention is capable of placing weld material to enhance some property of the produced product. One such enhancement may be inclusion of fins to increase surface area to enhance cooling or impart turbulence to a fluid passing through a passage.

Another embodiment of the invention contemplates a method step and system further comprising the capability to combine additional weld materials, said materials having different properties and being emplaced in engineered geometries allowing for production of parts using the invention that have unique properties. One such capability of the invention is placing a high strength brittle alloy in alternating fashion in three dimensions with a ductile alloy which would result in a material or part, produced using the invention method and system, having bulk properties that are neither ductile nor brittle, similar to Damascus steel, but having different materials strategically and precisely placed within the part to achieve selected, engineered properties. Similarly, the method and system of the invention is capable of placing a high strength, brittle alloy along one direction and a lower strength, ductile alloy in another resulting in an anisotropic part having properties that differ with direction. The number of possible combinations of weld material properties and geometry the method and system of the invention are capable of producing are infinite, making possible the production of parts having customizable properties.

The invention contemplates a system for and method of manufacturing a part using, among other forms of welding known in the art, GMAW, GTAW, Carbon Arc, Metal Arc, Plasma Arc, and laser welding.

One embodiment of the system of the invention is contemplated to comprise: a stand 611, a robotic controlled arc welding device 601, a processor containing an algorithm 613, a subject weld material 612 and a related conductive granular media 610.

Another embodiment of the system of the invention is contemplated to comprise: a combined robotic controlled welding device 601 and conductive granular media feeder or spreader for distributing support media 607, a processor containing an algorithm 613, a subject weld material 612 and a related conductive granular media 610.

Another embodiment of the system of the invention is contemplated to further comprise: A robotic controlled welding device having two or more welding devices, one or more robotic controlled granular support media feeders/spreaders capable of selectively distributing media of different compositions and/or media geometries as required to accommodate the part design, a processor containing an algorithm, a subject weld material and a related conductive granular media.

Another embodiment of the system of the invention is contemplated to further comprise: A robotic controlled welding device having two or more welding elements, each having different sized welding filler and operated at the same or different conditions to affect the production rate and/or resolution of a part produced by the system of the invention, one or more robotic controlled granular support media feeders/spreaders capable of selectively distributing media of different compositions and/or media geometries as required to accommodate the part design, a processor containing an algorithm, a subject weld material and a related conductive granular media.

An embodiment of the invented system may comprise: one or more welding power supplies, apparatus for feeding one or more welding filler materials, e.g., wire feeder, one or more bulk solids feeders for controlled delivery of the granular conductive support media, a three or more axis robotic printing system with a boom or gantry 608 for controlling motion of welding device or torch(es) and granular support media delivery, motion control software or algorithm, and software for production of toolpaths. A computer-based central control system would control all motion and input and output required to safely complete production of a WAAMS part. In this embodiment, a computer 606 may contain a processor with an algorithm 613 and the computer may be electronically connected 614, such that it can provide at least one control signal to the welder 605, media spreader 607, and controller 603 of the system and configured to communicate a weld input to the welder, a media input to the media spreader, and a controller input to the controller.

The method steps of the invention include: Creation of a solid model of a desired part in software, Preparation of a toolpath, with or without compensation for material properties and geometry, where said tool path is contemplated to contain descriptions of motions of various tools (e.g., torches, granular media discharge ports, etc.) controlled by a robotic system in a language suitable for the robotic system employed (e.g., g- and m-code). The invention further includes method steps of converting the tool path into physical motion of the tools required to complete fabrication of the part, toggle and modulate the energy produced by the welder power supply, toggle and modulate the granular media delivery apparatus and toggle and modulate the addition rate of the weld filler material. The steps may be performed synchronously or sequentially as dictated by the geometry of the part, e.g., granular media could be deposited concurrent with the welding operation or only after the entire weld layer has been deposited. Similarly, deposition of support media may be added only when needed, e.g., several layers of weld material may be deposited then followed by deposition of support material immediately prior to deposition of the overhanging layer. Layers may be applied in an upwards orientation from the lowest portion of the tool path, as is done with other additive manufacturing methods. The culmination of steps result in a completed part which may be removed from the system and the loose granular support media recovered for future reuse. The part may then be machined to produce tolerances required by an application or design for the completed part.

At least one embodiment of the invention further contemplates method steps comprising heating, preparing, cooling, cleaning, corrosion proofing, or washing, locally or entirely, a part manufactured using WAAM with conductive granular media for support, according to a time schedule, haphazardly, as-needed to modify or enhance the properties of the completed part, consistently or inconsistently.

The system of the invention is contemplated to include components allowing for completion of the method steps herein described.

Target final part geometry will dictate requirements and a configuration of the system. Simplified examples of parts having internal and external overhangs are shown in FIG. 2. Fully enclosed final parts having only internal overhanging geometry can act as their own vessels for containing the granular support media. Parts that are not fully enclosed or parts having external overhanging geometry will require an enclosed fabrication volume to contain the required granular support media. In another embodiment, the system includes a fabrication volume having adjustable dimensions such that the volume and mass of granular support media may be minimized by the system having fabrication volume dimensions to just enclose a complete part. As only a fraction of the support media may be incorporated in the final part, the system and method may also include elements and steps for recovery of loose media for reuse. Such provisions may include for instance, granular media collection facilities under the system; a vacuum system for media recovery; a magnetic media recovery system where appropriate. To the degree possible, this recovery system may also be automated.

The method of the invention may be substantially performed by a user or a computer.

In one embodiment, only those portions of the granular support media in direct contact with molten welding filler material or the energy source employed to melt the weld filler material may be incorporated in the final part. Granular support media may be of identical composition as the welding filler metal or a different composition.

As with many additive manufacturing methods, the part is created layer-by-layer, with subsequent layers atop previous layers, progressing upwards. The system and method of the invention are capable of completely filling solid portions of parts with the subject weld material or portions of parts may be partially filled, with the proportion set at the time the tool path is created. Part outlines and long infill may be completed in a single pass or split into multiple shorter lengths to alter or spread out the energy emplaced as a result of depositing molten metal onto a part.

The steps of the method of the invention may be completed in the order as described, or may be substantially performed in the order as described.

The method of the invention may further include a step for determining the amount of energy required for completing the welding and layering steps of the invention. The system of the invention may further have elements for modulating the amount of energy delivered based on e.g., wall thickness. The amount of energy emplaced is a consideration of the invention based on the type of material used to fabricate a part formed using the system for or method of the invention. For instance, an aluminum part requires less energy than does a steel part.

The configuration of granular support media in the system of the invention is selected based on the geometry of the part being fabricated. The deposition of molten metal presents a particular challenge when contemplating additive manufacturing; the liquid puddle has relatively low viscosity and easily flows until such time as it cools and solidifies. This significantly limits the angle with respect to the horizontal that a part geometry can make without the addition of granular support media. Granular support media contemplated as part of the system of the invention may be added immediately before depositing an overhanging layer having an angle exceeding the maximum possible for the given metal being used to fabricate the part. Addition of granular media in this fashion may be a step of an embodiment of the invention.

An embodiment of the invention further contemplates steps, and elements of the system of the invention, for heating or cooling the granular support media being e.g., the media may be preheated prior to addition or the entire bed of support media may be heated. The elements may be part of a media container 609 or media spreader 607, or the elements may be an external heater, cooler, oven, refrigerator, torch, fan, or other component known in the art of managing the temperature of manufacturing materials 610.

As another step of a further embodiment of the invention, the final part may be heat treated by methods known in the art of heat treating to alter its properties, e.g., hardness, toughness, etc. Such treatment would be designed to produce the desired properties. An embodiment of the system of the invention, therefore, is contemplated to contain elements for heat treating. Such heating elements may be part of the baseplate of the system, or the heating elements may be an external heater, cooler, oven, refrigerator, torch, fan or other component known in the art of managing the temperature of parts.

The method of the invention further contemplates steps for determining and manufacturing varying thickness of walls produced by WAAMS which is dependent upon the size of the welding filler material and operating conditions of the welder power supply, and therefore variable depending upon the needs of the part being produced. The invention further contemplates steps for adjusting production rate of the layers, altered to suit the requirements of the part, e.g., large parts with low resolution requirements can be produced with a larger welding filler wire material and higher energy inputs whereas areas or parts requiring greater resolution can be made with finer welding filler wire and lower energy inputs.

The method and system of the invention are suitable for use with any metal alloy systems used for welding.

The support media composition of the system of the invention, in at least one embodiment, may be in the same alloy system as the welding filler metal, e.g., steel support media will be used with steel welding filler, aluminum alloy support media with aluminum alloy welding filler, etc. The composition of the support media need not necessarily match that of the welding filler metal to effect a skin having different composition and therefore properties different from that of the bulk part, as outlined previously.

The method is scalable, capable of producing parts having dimensions of an inch or less to several feet. The system is likewise scalable.

The invention further contemplates, in at least one embodiment, the system of the invention further comprising a processor containing an algorithm, and a controller. The method steps for such an embodiment of the invention further comprises steps for uploading or downloading the algorithm to the processor of the invention, and steps for a user, whether computer or person, determining and setting method and system control points using the controller of the invention and uploading of tool paths.

At least one embodiment of the method of the invention contemplates all of the aforementioned method steps.

At least one embodiment of the system of the invention contemplates all of the aforementioned elements.

At least one embodiment of the invention contemplates use of only one of the method steps.

Other embodiments of the invention are contemplated to use the plurality of described method steps in all combinations, from one method step to all method steps.

Diagrams included with this disclosure are representative, and are in no way limiting.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

As such, those skilled in the art will appreciate that the conception upon which this disclosure is based may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

1. A system for producing a weld arc additive manufacturing part comprising:
a first granular media;
a first subject weld material;
a welder, the welder further comprising
a welder main body and
a weld device having a welding element configured to discharge the first subject weld material and to affect a production rate and a resolution of a weld arc additive manufacturing part formed with the system, wherein the weld device is spaced at a distance from the welder main body and configured to move independently from the welder main body;
a base plate; and
a toolpath.

2. The system of claim 1, wherein the first granular media is electrically conductive.

3. The system of claim 1, wherein the first granular media is configured to support the first subject weld material.

4. The system of claim 1, wherein the first granular media further comprises a first set of metallic properties, the first set of metallic properties comprising at least one metallic property.

5. The system of claim 4, wherein the first subject weld material further comprises a second set of metallic properties, the second set of metallic properties comprising at least one different metallic property from the first set of metallic properties.

6. The system of claim 1, wherein the weld arc additive manufacturing part with electrically conductive first granular media as support further has at least one geometric feature from the group consisting of an overhang, a hollow section, an opening, a geometry having a discontinuous structure when formed by the system that is joined, and a combination of geometries known in the art of manufacturing that could heretofore be produced by cutting and assembling a variety of different parts.

7. The system of claim 1, further comprising a frame configured to substantially enclose the first granular media.

8. The system of claim 1, wherein the first granular media is mono-sized having a bulk density less than a density of the first subject weld material.

9. The system of claim 1, wherein the first granular media has a geometry selected from the group consisting of: spherical, acicular, lamellar, star-like, and jack-shaped.

10. The system of claim 1, further comprising a second granular media.

11. The system of claim 10, wherein the second granular media is electrically conductive.

12. The system of claim 11, wherein the second granular media further comprises a third set of metallic properties, the third set of metallic properties comprising at least one different metallic property from the first set of metallic properties.

13. The system of claim 1, further comprising:
a vibration device, wherein the vibration device is configured to vibrate the base plate;
a first granular media temperature management element; and
a weld arc additive manufacturing part temperature management element.

14. The system of claim 1, further comprising:
a robotic printing system;
a controller;
a media spreader; and
a media container,
wherein the robotic printing system is configured to receive a movement input and to move in a horizontal, a vertical, and a lateral direction about a top surface of the base plate,
wherein the controller is configured
to receive a controller input,
to be in electronic communication with the robotic printing system, and
to deliver the movement input to the robotic printing system,
wherein the robotic printing system has at least three axes and is configured to hold the weld device,
wherein the media container is removably connected to the media spreader and configured to contain at least one of the group consisting of the first granular media and the second granular media, and
wherein the media spreader is configured
to receive a media input, and
to transport at least one of the group consisting of the first granular media and the second granular media from the media spreader to the baseplate.

15. The system of claim 14, further comprising a computer with a processor having an algorithm, wherein the computer is electronically connected to the welder, the media spreader, and the controller of the system and configured to communicate a weld input to the welder, a media input to the media spreader, and a controller input to the controller.

16. The system of claim 1, wherein the weld device of the welder further comprises a second welding element configured to discharge a second subject weld material and to affect the production rate and the resolution of the weld arc additive manufacturing part formed with the system.

17. The system of claim 1, further comprising a loose media recovery element configured to collect the first granular media.

18. A method for producing a weld arc additive manufacturing part, the method comprising:
determining a geometry and a size of a weld arc additive manufacturing part;
determining a toolpath;
determining a first subject weld material for forming the weld arc additive manufacturing part;
determining a first granular media for forming the weld arc additive manufacturing part;
determining a material composition strategy and a compaction strategy for forming the weld arc additive manufacturing part;
determining a need of an anchor for forming the weld arc additive manufacturing part;
determining a first subject weld material feed rate and an initial welding energy level;
preparing a toolpath;
converting the toolpath into a physical motion of a welding device attached to a welder;
depositing a first layer of the first granular media on a baseplate;
starting an arc with the first subject weld material using the welder by substantially contacting a welding device of the welder and the first granular media in a predetermined location;
printing the first subject weld material directly on the first granular media using the welder according to the toolpath;
melting the first granular media to create a substantially constant composition of first subject weld material and first granular media;
depositing an additional layer of the first granular media on a previous layer of the first granular media;
compacting the additional layer to a predetermined density;
varying and controlling an energy level of the welder and a feed rate of first subject weld material in the welder;
printing the first subject weld material using additive steps, according to the determined tool path, by repeating the steps for:
compacting each additional layer of the first granular media to the predetermined density,
varying and controlling the energy level of the welder and the feed rate of first subject weld material in the welder,
printing the first subject weld material using additive steps,
melting the first granular media to create the substantially constant composition of first subject weld material and first granular media for each additional layer, and
depositing an additional layer of the first granular media on a previous layer of the first granular media;
recovering un-melted first granular media; and
cleaning the weld arc additive manufacturing part.

19. The method of claim 18 further comprising:
determining a second subject weld material for forming the weld arc additive manufacturing part,
determining a second granular media for forming the weld arc additive manufacturing part,
depositing a first layer of the second granular media on a layer of the first granular media,
starting an arc with the second subject weld material using the welder by substantially contacting the welding device of the welder in a predetermined location on the second granular media,
printing the second subject weld material directly using the welder on the second granular media,
melting the second granular media to create a substantially constant composition of second subject weld material and the second granular media,
depositing an additional layer of the second granular media on a previous layer of the second granular media,
compacting the additional layer of the second granular media to a predetermined density, and
printing the second subject weld material using additive steps by repeating the steps of
compacting the additional layer of the second granular media to the predetermined density,
varying and controlling the energy level of the welder and a feed rate of second subject weld material in the welder,
printing the second subject weld material using additive steps,
melting the second granular media to create a substantially constant composition of second subject weld material and second granular media, and
depositing an additional layer of the second granular media on a previous layer of the second granular media.

20. The method of claim 19, wherein determining the geometry and the size of the weld arc additive manufacturing part further includes:
determining the weld arc additive manufacturing part having at least one geometric feature from the group consisting of:
an overhang,
a hollow section,
an opening,
a geometry having a discontinuous structure when formed by additive manufacturing steps that is joined, and
a combination of geometries known in the art of manufacturing that is produced by one of cutting and assembling a variety of different parts; and
wherein determining the toolpath is preceded by creating a solid model of the weld arc additive manufacturing part using a computer having a processor with an algorithm,
wherein converting the toolpath into a physical motion of the welding device attached to the welder is performed using the computer having the processor with the algorithm,
wherein the steps for varying and controlling the energy level of the welder and the feed rate of the first subject weld material in the welder and the feed rate of the second subject weld material further include using the computer having the processor with the algorithm,
wherein each step is controlled using the computer having a processor with an algorithm, as well as a controller that is configured
to receive a controller input from the computer,
to be in electronic communication with a robotic printing system holding the welding device,
to deliver a movement input to the robotic printing system holding the welding device, and
to be in electronic communication with a media spreader which is in turn configured to receive a media input from the computer having the processor with the algorithm and configured to transport a granular media from a media container to a baseplate.

21. The method of claim 20 wherein determining the first granular media further comprises:
selecting a high carbon material as the first granular media,
wherein determining the second granular media further comprises selecting a stainless steel as the second granular media, and
wherein determining the material composition strategy further comprises selecting a strategy for forming the weld arc additive manufacturing part with the first and second granular media.

22. The method of claim 18 wherein determining the need of the anchor for forming the weld arc additive manufacturing part further includes:
determining to use the anchor for forming the weld arc additive manufacturing part;
printing the anchor to a frame in at least the first layer of the first granular media; and
cutting the weld arc additive manufacturing part from the anchor prior to cleaning the weld arch additive manufacturing part.

23. The method of claim 18, wherein printing the first subject weld material directly on the first granular media using the welder further includes forming the weld arc additive manufacturing part that is substantially disconnected from a frame.

24. The method of claim 18 further comprising managing the first granular media temperature and managing the weld arc additive manufacturing part temperature.

25. The method of claim 19 further comprising:
depositing the additional layer of the first granular media on a layer of the second granular media, and
printing one from the group consisting of the first subject weld material and the second subject weld material using additive steps by repeating the steps for compacting the additional layer of the first granular media to the predetermined density,
varying and controlling the energy level of the welder and the feed rate of one from the group consisting of the first subject weld material and the second subject weld material in the welder,
printing one from the group consisting of the first subject weld material and the second subject weld material using additive steps,
melting the first granular media to create the substantially constant composition of one from the group consisting of the first subject weld material and the second subject weld material and first granular media;
starting the arc with the second subject weld material using the welder by substantially contacting the welding device of the welder in the predetermined location on the first granular media,
printing the second subject weld material directly using the welder on the first granular media,
melting the first granular media to create the substantially constant composition of second subject weld material and the first granular media, after depositing the additional layer of the first granular media on the layer of the first granular media, and
printing the second subject weld material using additive steps by repeating the steps for compacting the additional layer of the first granular media to the predetermined density,
varying and controlling the energy level of the welder and the feed rate of second subject weld material in the welder,
printing the second subject weld material using additive steps,
melting the first granular media to create the substantially constant composition of second subject weld material and first granular media, and
depositing an additional layer of the first granular media on the previous layer of the second granular media;
starting the arc with the first subject weld material using the welder by substantially contacting the welding device of the welder in the predetermined location on the second granular media,
printing the first subject weld material directly using the welder on the second granular media,
melting the second granular media to create the substantially constant composition of first subject weld material and the second granular media, after depositing the additional layer of the second granular media on the layer of the second granular media, and
printing the first subject weld material using additive steps by repeating the steps for compacting the additional layer of the second granular media to the predetermined density,
varying and controlling the energy level of the welder and the feed rate of first subject weld material in the welder,
printing the first subject weld material using additive steps,
melting the second granular media to create the substantially constant composition of first subject weld material and second granular media, and
depositing the additional layer of the second granular media on the previous layer of the second granular media.
